(19) United States
(12) Patent Application Publication
(10) Pub. No.: US 2009/0049093 A1
(43) Pub. Date: Feb. 19, 2009

(54) Custom User Pages for Participants in a Two-Way Communication

(75) Inventors: Tomas Karl-Axel Wassingbo, Lund (SE); Markus Mans Folke Andreasson, Lund (SE); Charles Liu, Chapel Hill, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/852,382

(22) Filed: Sep. 10, 2007

Related U.S. Application Data
(60) Provisional application No. 60/955,953, filed on Aug. 15, 2007.

(51) Int. Cl. G06F 3/048; G06F 17/30

(52) U.S. Cl. 707/104.1; 715/764; 707/E17.009

(57) ABSTRACT

A method for creating and displaying custom user pages for participants in a two-way communication is described. A content profile for a second party in a two-way communication is selected or retrieved responsive to a triggering event. The content profile includes one or more content identifiers that identify content of interest to or otherwise relevant to the second party. Media content corresponding to said content identifiers in said content profile is downloaded from one or more remote content servers. The downloaded media content is used to create a custom user page for the second party to be displayed on a mobile terminal of a the first party.

### RELATED APPLICATION

This application claims the benefit of U.S. Provisional Patent Application 60/955,953 filed on Aug. 15, 2007, which is incorporated herein by reference.

### BACKGROUND OF THE INVENTION

The present invention relates generally to user interfaces for mobile terminals and, more particularly, to a customizable user interface with dynamic content depending on the identity of a participant in a two-way communication.

Mobile terminals have evolved over the years to provide not only voice services, but also to provide a wide array of data services. Users of mobile terminals are now able to browse web pages, compose and read email messages, chat with their friends and acquaintances, download music and/or video files from Internet servers, and send digital photographs to their friends. Many mobile terminals are capable of concurrent voice and data communications. With concurrent voice and data, a user can, for example, send a photograph to a friend while engaged in a telephone conversation with that friend. Thus, the ability to engage in concurrent voice and data communications provides an opportunity to create a richer and more satisfying experience for the user.

When a user is engaged in a two-way communication with a friend or acquaintance, the user may want to have certain information available that is of interest to, or relevant to, the other party. Information that may be of interest to the other party can comprise, for example, the current weather, sports scores, stock prices, general or industry news. Currently, there is no convenient way to make such information available to a participant in a two-way communication.

### SUMMARY

The present invention provides a method and apparatus for creating and displaying custom user pages for participants in a two-way communication. One or more content profiles are stored in memory. Each content profile is associated with a user identifier. In response to a triggering event, the user identifier associated with a participant in a two-way communication is determined and used to select or retrieve a corresponding content profile. The content profile includes one or more content identifiers defining content relevant to the participant. Media content corresponding to the content identifiers in the content profile is downloaded from one or more remote content servers. A custom user page for the participant is created from the media content downloaded from the remote content servers and displayed on the mobile terminal of the other party. The custom user page includes one or more content items, such as the current weather, sports scores, stock prices, or news items that are relevant to the participant.

### BRIEF DESCRIPTION OF THE DRAWINGS

FIG. 1 illustrates an exemplary communication network.

FIG. 2 is a block diagram illustrating the main functional components of a mobile terminal.

FIG. 3 is a block diagram illustrating the main functional components of an application server or content server.

FIG. 4 illustrates a custom user page displayed on a mobile terminal.

FIG. 5 illustrates a general method for creating custom user pages.

FIG. 6 illustrates a method for creating custom user pages wherein custom user pages are created by a mobile terminal.

FIG. 7 illustrates a method for creating custom user pages wherein custom user pages are created by an application server.

FIG. 8 illustrates a method for creating custom user pages wherein custom user pages are created by a mobile terminal from content profiles provided by an application server.

### DETAILED DESCRIPTION

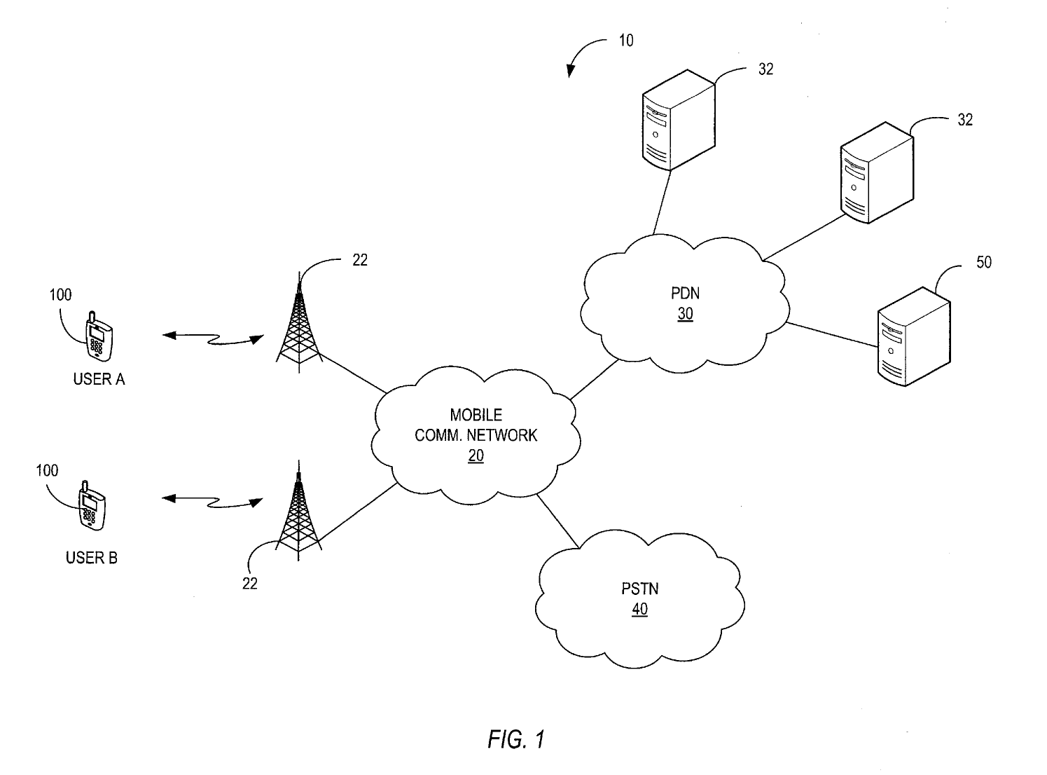

Referring now to the drawings, the present invention will be described in the context of an communication network 10 as shown in FIG. 1. The communication network 10 comprises a mobile communication network 20 having one or more base stations of wireless access points 22 for communicating with mobile terminals 100. The mobile terminals 100 may comprise, for example, cellular telephones, personal digital assistants, laptop computers, or other mobile devices. The mobile communication network 20 connects to a packet data network 30 and to the public switched telephone network (PSTN) 40. The PDN 30 comprises a packet-switched network that implements known protocols, such as conventional Internet protocols. The PDN 30 may comprise a public or private network, and may be a wide area or local area network. The Internet is one well-known example of a PDN 30. The PSTN 40 is a circuit-switched network 40 for both voice and data communications.

One or more content servers 32 connect to the packet data network 30. The content servers 32 are accessible to the mobile terminals 100 via the mobile communication network 20 and packet data network 30. The content servers 32 may, for example, comprise web servers, email servers, file servers, or other types of servers. In some embodiments of the invention, an application server 50 may be used to implement certain operations as hereinafter described.

FIG. 1 illustrates two mobile terminals 100, though there may in fact be hundreds or thousands. The mobile terminals 100 are identified as being owned by User A and User B, respectively. When User A makes a call to or receives a call from User B, media content or information relevant to User B may be downloaded from one or more content servers 32 and used to generate custom user pages for User B. The custom user pages may be displayed on the mobile terminal for User A. Similarly, the media content relevant to User A may be downloaded from the content servers 32 and used to generate a custom user page for User A. The custom user page for User A may be displayed on User B's mobile terminal 100. Thus, both User A and User B will have information available to them relevant to the other party. Such information may comprise, for example, the current weather, sports scores, stock prices, news, and links to personal web pages.

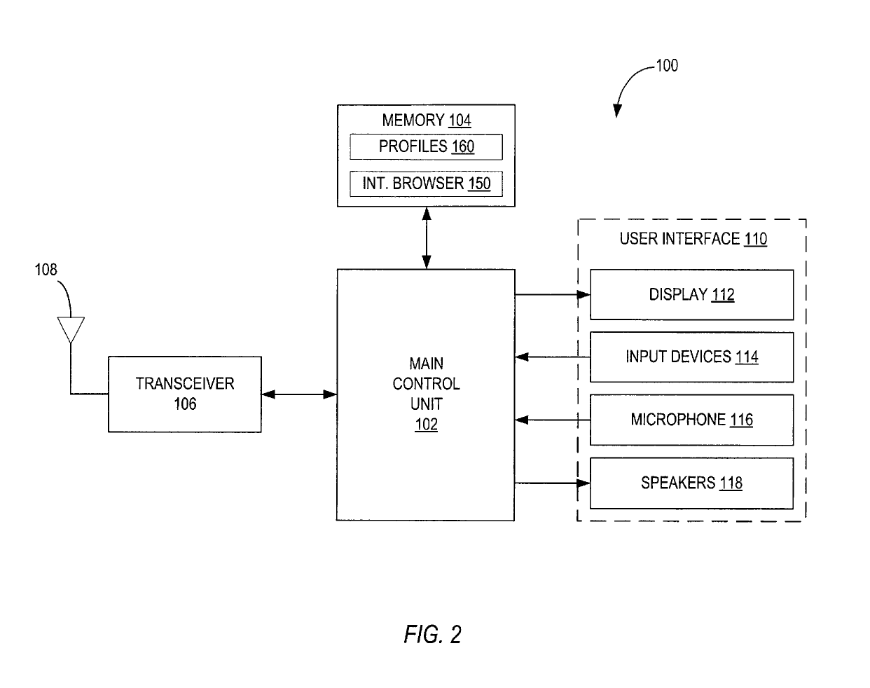

FIG. 2 illustrates an exemplary mobile terminal 100. The mobile terminal 100 comprises a main control unit 102, memory 104, a wireless transceiver 106 connected to an antenna 108, and a user interface 110. The main control unit 102 is responsible for the overall operational control of the mobile terminal 100 according to programs and instructions stored in memory 104. The main control unit 102 may comprise one or more microprocessors, microcontrollers, hardware circuits, or a combination thereof. Memory 104 stores data and programs needed for operation. Programs stored in memory may include, for example, an operating system program and one or more application programs. The memory 104 may comprise one or more discrete memory devices, including read-only memory devices, random access memory, flash memory, etc. Memory 104 may further include optical or magnetic storage devices.

Transceiver 106 may comprise any known type of wireless transceiver to enable communication with other devices. The transceiver 106 may, for example, comprise a cellular transceiver operating according to conventional cellular standards, such as GSM and WCDMA, a WiFi transceiver operating according to the 802.11 family of standards, or a Bluetooth transceiver. Although only one transceiver 106 is shown, the mobile terminal 100 could have multiple transceivers, each operating according to a different communication standard.

The user interface 110 provides means for user interaction with the mobile terminal 100. The user interface 110 comprises a display 112, one or more user input devices 114, a microphone 116, and speaker 118. The main control unit 102 may output information to display 112 for viewing by the user. The display 112 may comprise, for example, a liquid crystal display (LC) or touchscreen display. One or more user input devices 114 provide user input to the main control unit 102. User input devices 114 may comprise, for example, a keypad, navigation controls, thumb wheels, buttons, etc., or other known types of computer input devices. A touchscreen display 112 could also be used as an input device 114. Microphone 116 converts audible sounds into audio signals for input to the main control unit 102. Conversely, speaker 118 converts audio signals output by the main control unit 102 into audible sounds that may be heard by the user.

The mobile terminal 100 may provide a variety of data services in addition to conventional voice communication services. These additional services may include, for example, text messaging, email, and web browsing. Such services are typically provided by application programs stored in memory 104 and executed by the main control unit 102. Exemplary applications include, in addition to an operating system program, a contact manager or address book, a calendar program, an email client, and a web browser.

In one exemplary embodiment, mobile terminal 100 includes an intelligent browser 150. The intelligent browser 150 provides functionality similar to a conventional web browser. The intelligent browser 150 may implement standard Internet protocols, such as HTTP, FTP, RTP, and MSRP to access and download information or media content from remote content servers 32 accessible via the Internet or other PDN 30. For example, the intelligent browser 150 may download files from an FTP server, retrieve email from an email server, and retrieve web pages from a web server responsive to user requests in the same manner as a conventional browser. The intelligent browser 150 may be a stand alone program, or part of an integrated program that performs other functions in addition to browsing.

The intelligent browser 150 may be configured to download information or media content from content servers 32 responsive to a triggering event, such as an incoming call from a remote party, without an explicit user request for the information. For example, a content profile 160 including one or more content identifiers may be defined for persons entered into the user's contact list or address book. The content identifiers identify information that is potentially of interest to, or relevant to, the persons with whom the user regularly communicates. The content profiles 160 may be stored in the memory 104 of the mobile terminal 100. The content profiles 160 may be associated with contacts in the users contact list or address book. When a first user (e.g., User A) makes a call to or receives a call from a second party (e.g., User B), an identifier associated with User B may be used to select a content profile 160 associated with User B. Based on the content profile 160, the intelligent browser 150 may download selected media content from content servers 32 corresponding to the content identifiers in the selected content profile 160. The intelligent browser 150 may then create a custom user page from the downloaded media content for User B to be displayed by the mobile terminal 100 for User A.

In another embodiment of the present invention, an application server 50 may store content profiles 160 in its memory and create custom user pages. When a user (e.g., User A) receives a call from another party (e.g., User B), the mobile terminal 100 for User A may send a request for a custom user page to the application server 50. The request may include an identifier associated with User B. The application server 50 may select the content profile 160, download media content corresponding to the content identifiers in the content profile 160, and create the custom user page for the remote party. The custom user page may then be transmitted to User A for display to on Use A's mobile terminal 100.

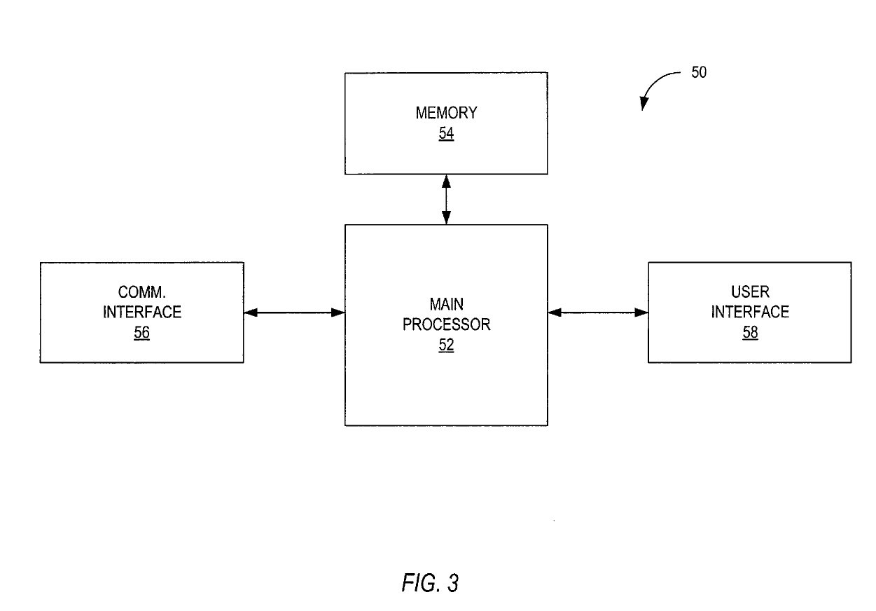

FIG. 3 illustrates an exemplary application server 50. The application server 50 comprises a main processor 52, memory 54, and a communication interface 56. The main processor 52 controls the operation of the application server 50. The main processor 52 may comprise one or more microprocessors, microcontrollers, hardware circuits, or a combination thereof. Memory 54 stores applications executed by the main processor 52, an may store content profiles 160 in some embodiments. The memory 54 may comprise one or more discrete memory devices, including read-only memory devices, random access memory, flash memory, etc. Memory 54 may further include mass storage devices, such as optical or magnetic storage devices. Such applications include operating system applications and server applications. Communication interface 56, such an Ethernet interface, connects the application server 50 to the packet data network 30. The application server 50 may further include a user interface 58 to enable maintenance by the operator of the application server 50. The user interface 58, however, is not needed for practicing the present invention.

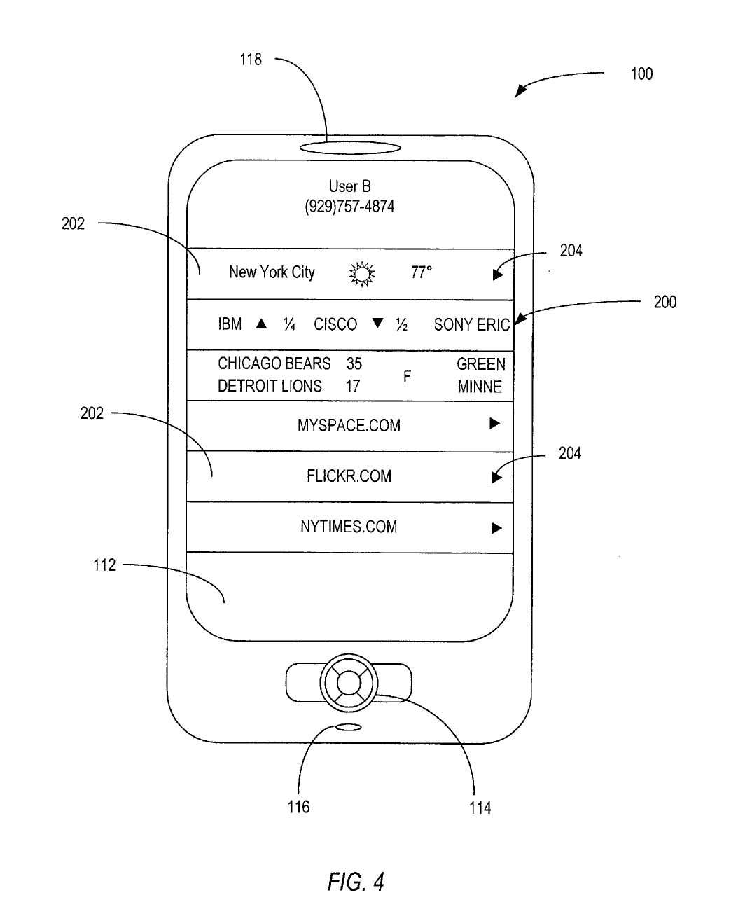

FIG. 4 illustrates an exemplary custom user page 200 for User B. The identity and telephone number of User B is displayed at the top of the user page. As will be described hereinafter in detail, the telephone number may serve as an identifier for User B to select User B's content profile 160 when a call is made to or received from User B. In addition to the user name and telephone number, the illustrated custom user page 200 includes six content items 202 that have been assembled based on the content profile 160 for User B. Each content item 202 corresponds to one of the content identifiers in User B's content profile 160. The content items 202 on the custom user page 200 may display information of interest to User B and/or provide links to additional user pages containing information relevant to User B.

In the example shown in FIG. 4, the first content item 202 provides weather information for a locality of interest to User B. Indicator 204 indicates that the first content item 202 links to additional information. Selecting the first content item 202, such as by clicking on the content item 202, results in a new page being displayed. In this case, selecting the first content item 202 may cause a web page providing more detailed weather information to be displayed. The second content item 202 comprises a stock ticker including stocks of interest to User B. The stock ticker may scroll as is known in the art to provide information about a plurality of stock prices. The third content item comprises a sports ticker that provides scores for sporting events of interest to User B. The last three content items 202 comprise links to web sites associated with User B by the content profile 160. One provides a link to User B's personal web page at MySpace.com. Another provides a link to User B's personal web album at flicker.com. The last content item 20 links to the NY Times web page, and may be used to select news items of interest to User B.

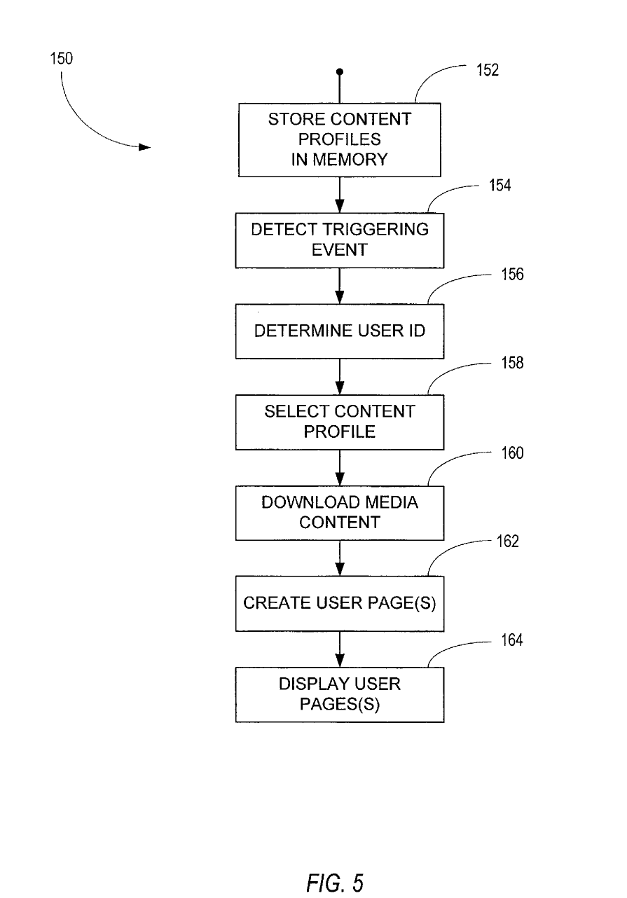

FIG. 5 illustrates a general method 150 for generating custom user pages for participants in a two-way communication. Content profiles 160 for persons listed in a contact list or address book of a first user (e.g., User A) are stored in a database (block 152). The content profiles may be stored in memory 104 of User A's mobile terminal 100, or in by an application server 50. The content profiles 160 may be stored as part of the contact information in the contact list or address book. When a triggering event is detected (block 154), the mobile terminal 100 determines a user identifier for the other party (e.g., User B) (block 156). If the content profiles are stored by the mobile terminal 100, the mobile terminal 100 correlates User B's identifier with the contacts in its contact list to select User B's content profile 160 (block 158). If the content profiles 160 are stored by the application server 50, the mobile terminal 100 sends a request with the user identifier for User B to the application server 50. In this case the application server 50 correlates the user identifier with the content profile and selects the content profile for User B. If no content profile is associated with the identifier, the mobile terminal 100 or the application server 50 may select a default content profile 160.

The content profile 160 includes one or more content identifiers. The content identifiers may, for example, comprise addresses, such as web addresses, for resources on the Internet. The content identifiers may comprise fully qualified addresses, or may comprise partial addresses that need to be completed based on other information. As an example, User B may send location information to User A indicating User B's current location. The location information may be used to complete or modify content identifiers to select location-specific information (e.g., current weather) relevant to User B's current location. Location specific information may, alternatively, be selected based on User B's telephone number.

Either the mobile terminal 100 or application server 50 downloads media content corresponding to the content identifiers in the content profile 160 (block 160). The downloaded media content is then used to create one or more user pages for User B (block 162). The downloading and page creation may be performed entirely by the mobile terminal 100, or entirely by the application server 50. Also, the downloading function may be implemented by the application server 50, while the page creation function is performed by the mobile terminal 100. In any case, the user page is displayed on the display 112 of User A's mobile terminal 100 (block 164).

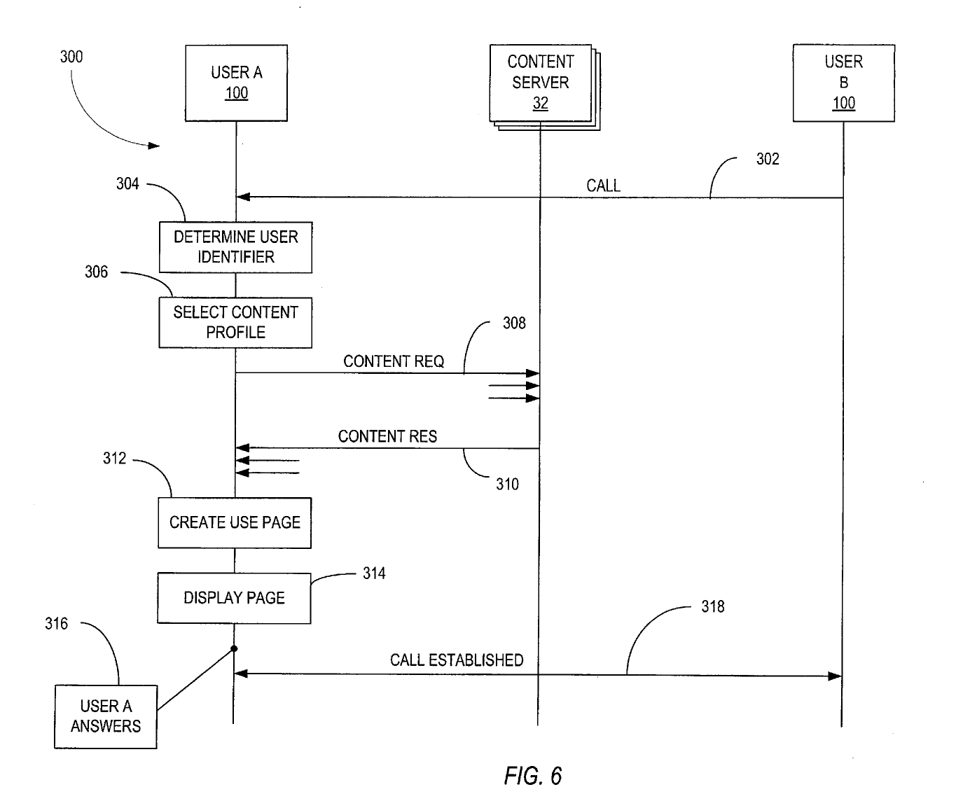

FIG. 6 is a call flow diagram illustrating a first exemplary method 300 for generating custom user pages implemented by a mobile terminal 100. In this example, it is assumed that the content profile 160 for User B is stored in memory 104 of User A's mobile terminal 100. User A receives an incoming call from User B (step 302). The incoming call serves as a triggering event for the creation of a custom user page for User B. Those skilled in the art will appreciate that a call made by User A to User B could also serve as a triggering event. In response to the call, User A's mobile terminal 100 determines an identifier for User B (step 304) and uses the identifier to select a content profile 160 stored in memory 104 of User A's mobile terminal 100 (step 306). If no content profile is associated with the identifier, the mobile terminal 100 may select a default content profile 160 (step 306). The user identifier may, for example, comprise User B's telephone number in the case of a voice call. For data communications, the user identifier may comprise an IP address, SIP address, or other similar identification. The mobile terminal 100 for User A correlates the user identifier with contacts in User A's contact list or address book and selects the content profile 160 for User B.

The intelligent browser 150 uses the content identifiers in the content profile 160 to select and download media content or information of interest to User B. The intelligent browser 150 for User A's mobile terminal 100 downloads media content corresponding to the content identifiers in User B's content profile 160. As noted previously, the media content may comprise files stored on a file server, web pages, audio and/or video files, or other resources. More particularly, the intelligent browser 150 may generate resource requests (e.g., HTTP GET requests) to request resources (e.g., web pages) corresponding to each content item (step 308). These requests may be sent to content servers 32 which, in response, provide the requested resources to the intelligent browser 150 (step 310).

Rather than immediately display or play the downloaded media content, the intelligent browser 150 creates a custom user page for User B from the downloaded media content (step 312). The intelligent browser 150 may create multiple, hyperlinked user pages from the media content. In the example shown in FIG. 4, the first page comprises a list of content items 202. Some of the content items 202 link to additional user pages. The custom user page, or the first page of a multi-page document, is displayed on the display 112 of User A's mobile terminal 100 (step 314).

Parallel with the creation and display of the user pages, User A may answer the incoming call (step 316). Those skilled in the art will appreciate that the call could be answered before the user pages for User B are created. Once the call is answered, a two-way communication is established and User A and User B may converse with one another (step 318). Once the user page for User B is displayed, the user pages may be used to facilitate conversation with User B. In this example, the user page for User B provides User A with weather information, stock prices, and sports scores that may be of interest to User B. The custom user page further provides links to User B's personal web page at MySpace and User B's web album at Flickr.com. User A may browse User B's MySpace pages and flicker pages during the conversation, which may provide topics for discussion with User B.

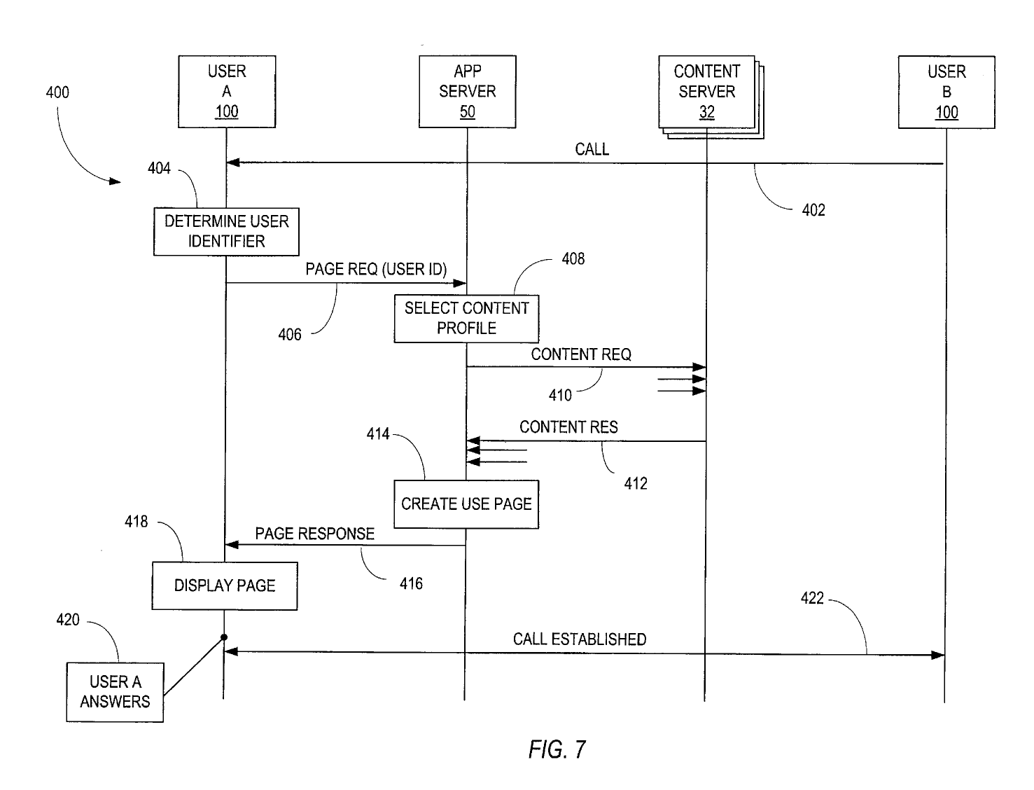

FIG. 7 illustrates a second method 400 for creating custom users pages for participants in a two-way communication by an application server 50. In this embodiment, User A receives an incoming call (the triggering event) from User B (step 402). In response to the call, the mobile terminal 100 for User A determines an identifier for User B (step 404) and sends a user page request to the application server 50 (step 406). The user page request includes a user identifier that uniquely identifies User B to the application server 50, such as User B's telephone number or IP address. The application server 50 correlates User B's user identifier with the content profile 160 stored by the application server 50 and selects the content profile 160 for User B (step 408). If no content profile is associated with the identifier, the application server 50 may select a default content profile 160 (step 408). As previously described, the content profile 160 includes one or more content identifiers that identify media content relevant to User B. The application server 50 downloads the media content pointed to by the content identifiers from one or more content servers. The application server 50 may use standard Internet protocols, such as HTTP, to send resource requests to content servers 32 (step 410) and receive the requested media content from the content servers (step 412). Once the media content is downloaded, the application server 50 generates one or more custom user pages from the media content (step 414) and forwards the custom user pages to mobile terminal 100 for User A as a response to the page request from User A (step 416). Upon receipt of the user pages from the application server 50, the mobile terminal 100 launches the intelligent browser 150 and displays the user pages (step 418). When User A answers the call (step 420), a two-way communication is established (step 422). As previously noted, the call may be answered before the user pages are received from the application server 50.

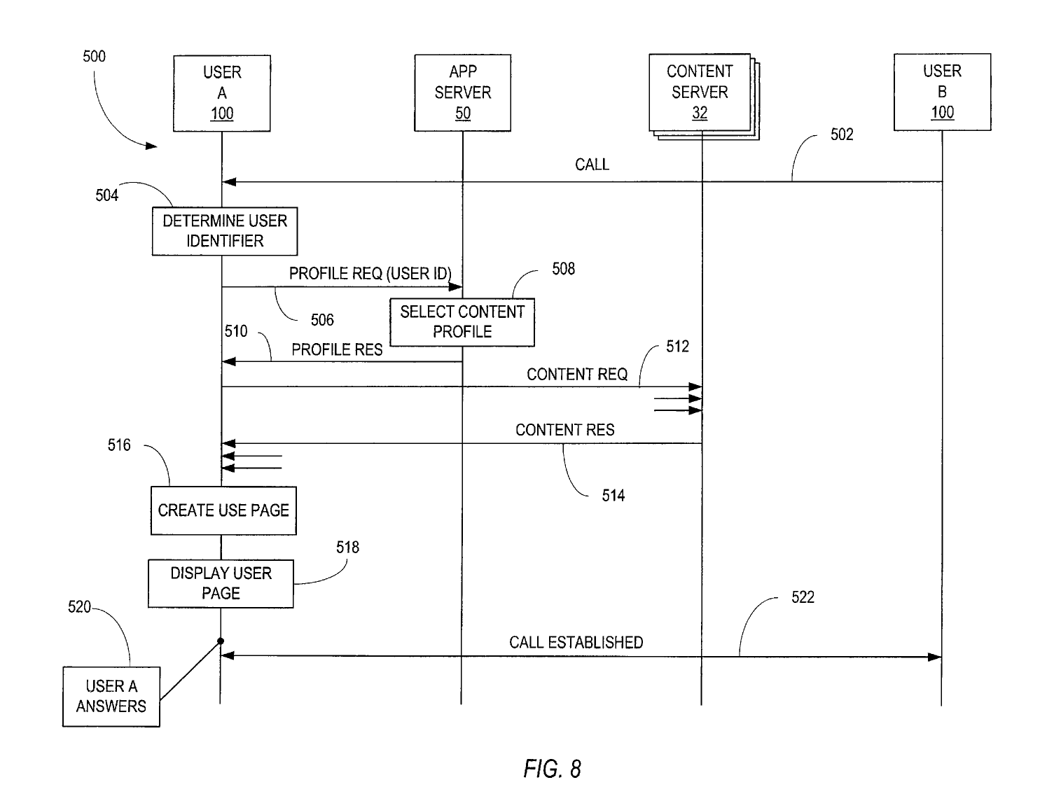

FIG. 8 illustrates a third method 500 for creating user pages wherein content profiles 160 are stored in a centralized application server 50. In this embodiment, the application server 50 provides content profiles 160 to the mobile terminals 100 responsive to requests from the mobile terminals 100. The content profiles 160 may then be used by the mobile terminals 100 to generate custom user pages as previously described.

When User A receives an incoming call from User B (the triggering event) (step 502), the mobile terminal 100 for User A determines an identifier for User B (step 504) and sends a content profile request to the application server 50 (step 506). The content profile request includes an identifier associated with User B, such as User B's telephone number, IP address, or SIP address. The application server 50 correlates the identifier with the content profiles 160 stored by the application server 50 or selects a default content profile 160 (step 508) and forwards the corresponding content profile 160 for User B to User A's mobile terminal 100 (step 510) as a response to the profile request. After receiving the content profile 160 from the application server 50, the intelligent browser 150 on User A's mobile terminal 100 sends resource requests to remote content servers 32 (step 512) and receives the requested media content from the content servers 32 (step 514). The intelligent browser 150 generates custom user pages for User B from the downloaded media content (step 516) and displays the custom user pages on the mobile terminal 10 (step 518). When User A answers the incoming call (step 520), a two-way communication is established (step 522).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of creating a user page for display on a mobile terminal of a first party in a two-way communication, said method comprising:
selecting a content profile for a second party in a two-way communication responsive to a triggering event, said content profile including one or more content identifiers;
downloading media content corresponding to said content identifiers in said content profile from one or more remote content servers; and
creating a custom user page for said second party to be displayed on a mobile terminal of a said first party from said media content downloaded from said remote content servers.

2. The method of claim 1 wherein selecting a content profile comprises selecting a content profile stored in memory of a mobile terminal of said first party.

3. The method of claim 2 wherein downloading media content and creating a custom user page is performed by an application on said mobile terminal of said first party.

4. The method of claim 1 wherein selecting a content profile comprises selecting a content profile stored in an application server.

5. The method of claim 4 wherein downloading media content and creating a custom user page is performed by a server application on said application server.

6. The method of claim 1 wherein said custom user page comprises a formatted list including one or more list items associated with respective content identifiers.

7. The method of claim 6 wherein at least one list item on said custom user page comprises a link to a second custom user page associated with the corresponding content identifier.

8. The method of claim 6 further comprising displaying said custom user page on a display of said mobile terminal for said first party.

9. The method of claim 1 wherein said content identifiers include at least one of a weather item, a sports item, a financial item, and a news item.

10. The method of claim 1 wherein said content identifiers include a web page associated with said second party.

11. The method of claim 1 wherein selecting a content profile comprises:
determining an identifier of said second party; and
selecting a custom content profile associated with said identifier from a contact database.

12. The method of claim 11 further comprising selecting a default content profile if no content profile is associated with said identifier.

13. The method of claim 1 wherein said content identifiers include at least one modifiable content identifier that is modified based on information received from said second party.

14. The method of claim 1 wherein said two-way communication comprises a voice call and wherein said triggering event comprises a call event associated with said voice call.

15. The method of claim 14 wherein said triggering event comprises making a call to or receiving a call from said second party.

16. A mobile terminal for a first party in a two-way communication, said mobile terminal comprising:
a display;
a transceiver; and
a processor connected to said display and said transceiver, said processor configured to:
retrieve a content profile for a second party in said two-way communication responsive to a triggering event, said content profile including one or more content identifiers;
download media content with said transceiver corresponding to said content identifiers in said content profile from one or more remote content servers;
create a custom user page for said second party from said media content downloaded from said remote content servers; and
display said custom user page on said display.

17. The mobile terminal of claim 16 wherein said custom user page comprises a formatted list including one or more list items associated with respective content identifiers.

18. The mobile terminal of claim 17 wherein at least one list item on said custom user page comprises a link to a second custom user page associated with the corresponding content identifier.

19. The mobile terminal of claim 16 wherein said content identifiers include at least one of a weather item, a sports item, a financial item, and a news item.

20. The mobile terminal of claim 16 wherein said content identifiers include a web page associated with said second party.

21. The mobile terminal of claim 16 wherein said processor is configured to retrieve a content profile by:
determining an identifier of said second party; and
selecting a custom content profile associated with said identifier from memory of said mobile terminal.

22. The mobile terminal of claim 16 wherein said processor is configured to retrieve a content profile by:
determining an identifier of said second party;
sending a request of a content profile to an application server, said request including said identifier associated with said second party; and
receiving a content profile from said application server responsive to said request.

23. The mobile terminal of claim 16 wherein said processor is configured to retrieve a default content profile if no content profile is associated with said identifier.

24. The mobile terminal of claim 16 wherein said content identifiers include at least one modifiable content identifier that is modified based on information received from said second party.

25. The mobile terminal of claim 16 wherein said two-way communication comprises a voice call and wherein said triggering event comprises a call event associated with said voice call.

26. The mobile terminal of claim 25 wherein said triggering event comprises making a call to or receiving a call from said second party.

27. An application server comprising:
memory for storing content profiles for one or more participants in a two-way communication;
a communication interface; and
a processor configured to:
receive a request from a mobile terminal, said request containing a user identifier; and
select a content profile corresponding to said user identifier from memory responsive to said request, said content profile comprising one or more content identifiers.

28. The application server of claim 27 wherein said processor is further configured to send said selected content profile to said mobile terminal responsive to said request.

29. The application server of claim 27 wherein said processor is further configured to:
download media content corresponding to said content identifiers in said content profile from one or more remote content servers;
create a custom user page for said second party from said media content downloaded from said remote content servers; and
send said custom user page to said mobile terminal responsive to said request.

30. The application server of claim 29 wherein said custom user page comprises a formatted list including one or more list items associated with respective content identifiers.

31. The application server of claim 30 wherein at least one list item on said custom user page comprises a link to a second custom user page associated with the corresponding content identifier.

32. The application server of claim 27 wherein said content identifiers include at least one of a weather item, a sports item, a financial item, and a news item.

33. The application server of claim 27 wherein said content identifiers include a web page associated with said second party.

34. The application server of claim 27 wherein said processor is configured to select a content profile associated with said identifier from a contact database.

35. The mobile terminal of claim 34 wherein said processor is further configured to select a default content profile if no content profile is associated with said identifier.

36. The mobile terminal of claim 27 wherein said content identifiers include at least one modifiable content identifier that is modified based on information received from said second party.
